(19) United States
(12) Patent Application Publication
(10) Pub. No.: US 2004/0016651 A1
(43) Pub. Date: Jan. 29, 2004

(54) Method for the manufacture of an implant, a method for the decontamination of a surface treated with blasting particles and a medical implant

(76) Inventor: Markus Windler, Hofstetten (CH)

Correspondence Address: CHRISTIE, PARKER & HALE, LLP, P.O. BOX 7068, PASADENA, CA, 91109-7068, US

(21) Appl. No.: 10/392,643

(22) Filed: Mar. 20, 2003

(30) Foreign Application Priority Data
Jul. 24, 2002 (EP) 02 016 564.3

(51) Int. Cl. B23H 5/06

(52) U.S. Cl. 205/661; 205/662; 205/682; 205/685

(57) ABSTRACT

A method is provided for the manufacture of an implant, in particular of a metallic implant, comprising the steps of roughening the surface of the implant by blasting with blasting particles and of treating the surface with a solvent which selectively dissolves the blasting particles.

The invention relates to a method for the manufacture of an implant, to a method for the decontamination of a surface treated with blasting particles and to a medical implant.

With bone implants such as joint implants, the surfaces which are anchored in the bone material are treated with blasting particles to roughen the surfaces. In the blasting, solid particles in the form of grains are mixed with a gas flow led through a nozzle and shot onto the surface at pre-determined angles. A rough surface structure is thereby produced such that, for example with stem prostheses which are anchored directly in the bone at the stem, the bone material can grow in a shape matched manner up to the undercut sections of the surface. A rough surface structure is also desired with implants which are cemented in, such as stem prostheses or joint shells, in order to give the bone cement a better grip. In addition, the prosthesis surfaces are compacted by the bombardment with the particles and are much less sensitive to cracking with alternating strains under the internal stress produced in this manner. This is in particular important with a femur stem prosthesis having a slender neck. An implant can also be roughened at points not to be anchored to provide the physician with additional grip on the insertion of a prosthesis.

The blasting of implant surfaces with corundum particles is known. Such blasted surfaces, however, also have particles which have penetrated into the surface and have stuck there or adhere to the surface even after the treatment in cleaning baths. Such particles can have a disadvantageous effect after the implanting, for example if they detach mechanically, penetrate between the articulation surfaces of an artificial joint, reduce its service life and can therefore bring about the same negative effects as, for example, bone cement abrasion.

It is the object of the invention to provide a method for the manufacture of an implant whose surface has been roughened with blasts, but is not contaminated with the blasting material used.

The object is satisfied by the features of claim 1.

Advantageous embodiments of the invention are set forth in the description and in the dependent claims.

The object is in particular satisfied by roughing the surface of the implant by blasting with blasting particles and treatment of the surface with a solvent which selectively dissolves the blasting particles. An implant is thus manufactured having a surface which receives the desired rough surface structure by the blasting, but is not contaminated with the blasting particles which are embedded in the surface during blasting or adhere to it and can detach after the implanting of the prosthesis. The selecting dissolving of the blasting particles moreover results in the advantage that the roughened surface is not substantially changed by the treatment with the solvent.

The object is furthermore in particular satisfied in that the surface is treated with a solvent which selectively dissolves the blasting particles for the decontamination of a surface treated with blasting particles, in particular of a metallic implant surface treated with blasting particles.

In this manner, any surface treated with blasting particles, in particular an implant surface, can be liberated from the blasting particles which remain in and on the surface after the blasting and can thus be decontaminated.

The invention consequently consists of the combination of an implant surface, blasting particles and at least one solvent, with these components being matched to one another with respect to their relevant properties such that the blasting particles can roughen the surface in the desired manner and the solvent can dissolve the blasting particles, on the one hand, but at the same time does not further attack the surface.

The treatment of the roughened surface with solvents is also known as stripping.

The treatment of the surface can take place e.g. by means of chemical or electrolytic baths, i.e. by chemical or electrolytic stripping.

An acidic solvent can be used as the solvent in which the material of the implant is substantially insoluble, with the acid being an active ingredient which detaches the blasting particles from the surface or dissolves them.

For instance, the surface can be decontaminated by a simple treatment with an acidic solvent without complex cleaning processes being required.

The solvent can comprise HNO₃, H₃PO₄ and/or H₂SO₄. Even metallic blasting particles can thereby be detached from the surface or dissolved in a simple process which can be mastered without problem.

The treatment of the surface can include an immersion of the surface into a mechanically stirred acid as the solvent. This ensures a solution process in which all regions of the surface are treated with the solvent and can be decontaminated by the solvent.

The treatment of the surface can include an electrolytic treatment with an electrolyte as the solvent, in particular an anodic oxidisation. For instance, metallic blasting particles whose standard reference voltage differs in the electrical voltage series from the standard reference voltage of the respective material of the blasted metallic surface can be removed by electrolytic baths without causing any disadvantageous changes to the base material of the surface.

In this connection, the treatment of the surface can include an electrolytic treatment in an acid NaCl solution at 20° to 50° and at −500 to +800 mV. The treatment of the surface can in particular include an electrolytic treatment in an 0.9% NaCl solution of pH 4, at 40° C. and at +300 mV.

A cleaning of the surface can take place before the treatment with the solvent. Contaminations of the surface which prevent a wetting of the surface with the solvent can thereby be removed such that a complete dissolving or detaching of the blasting particles can take place.

The solvent can be conditioned in the treatment of the surface. The solvent thus also remains active with longer treatment procedures and the solution reaction is favourably influenced. The conditioning of the solvent can in particular take place by precipitation of the dissolved blasting particles.

The material of the surface can comprise a metal. For instance, metallic surfaces which have been roughened with blasting particles can also be liberated from blasting particles by the method in accordance with the invention.

The material of the surface can comprise Ti, an alloy of Ti, Ta, Zr, Nb, Co/Cr or stainless steel. Consequently, surfaces can be treated and decontaminated by the method in accordance with the invention which consist both of a metal and of a composite of a plurality of metallic elements and which can only be liberated from the blasting particles with difficulty by customary methods.

The blasting particles can include iron particles which can in particular be hardened. Even these particles, which are difficult to remove with known processes, can be selectively dissolved by the method in accordance with the invention.

In a particularly preferred embodiment, the surface can include titanium or a titanium alloy, the blasting particles can include iron particles and the treatment of the surface can include an immersion of the surface of up to three hours in a mechanically stirred approximately 10% HNO₃ as the solvent at room temperature. This combination of the blasting particles and of the solvent ensures that even a surface consisting of titanium or of a titanium alloy is provided with an adequate surface roughness and is moreover liberated from the iron particles required for the roughening, and indeed such that the base material is not attacked in a disadvantageous manner.

In this connection, before the treatment of the surface, a cleaning of the surface with industrial alcohol can take place and/or, on the treatment of the surface, the solvent can be conditioned by a precipitation of the dissolved blasting particles, in particular by iron precipitation. For instance, in the treatment of a surface of titanium, or of a titanium alloy, which is roughened using iron particles, an adequate wettability of the surface with the solvent can be effected by the cleaning of the surface with industrial alcohol before the treatment of the surface with a solvent. In addition, the solvent or the nitric acid is regenerated by the iron precipitation during the treatment of the surface, whereby the dissolving of the iron particles is favourably influenced.

The object is furthermore satisfied in that a medical implant, in particular a joint prosthesis, is provided comprising a surface which can be achieved by a method in accordance with any one of the preceding claims. The medical implant in accordance with the invention is roughened by blasting with blasting particles such that, with anchored stem prostheses, bone material can grow up to the undercut sections of the surface in a shape matched manner; with implants cemented in, the bone cement can be given a better grip; and, at the same time, the surface is compacted by the bombardment with particles. At the same time, the roughened surface is selectively liberated from the unwanted blasting particles such that a mechanical detachment of blasting particles remaining in and on the surface after the implanting can be avoided.

Further advantages of the invention lie in the fact that it can be used simply and is cost favourable to reliably obtain a surface roughened by blasting which is almost free of blasting means and to prevent complications which can arise in the implanted state by “wandering” blasting particles. It is furthermore of advantage that the stripping of the surface can take place at room temperature and in a comparatively short time (in a maximum of 3 hours with the preferred embodiments).

The invention will be described below purely by way of example.

In a first embodiment of the method in accordance with the invention, the surface of an implant consisting of titanium or of a titanium alloy is bombarded by blasting with hardened iron particles which consist of edged, broken cast steel blasting grains of high hardness. The grain size of the hardened iron particles amounts to approximately 0.07 to 1.7 mm, preferably 0.4 to 0.4 mm in order to achieve a roughness Ra which can lie between 0.5 and 14 μm, with a blasting pressure from approximately 1 to 6 bar and a distance of the nozzle used for the blasting from the implant surface of approximately 200 mm being observed. The samples are blasted until the surface has the desired degree of roughness, with it appearing uniformly matt grey. The surface of the implant is subsequently immersed for approximately 30 minutes at room temperature into a mechanically stirred solution of an approximately 10% nitric acid (HNO₃), with the iron particles remaining in or on the surface after the blasting process being dissolved or detached without the surface of titanium or of the titanium alloy being attacked.

The possibility is thus provided by the selection of a suitable threefold combination of surface material, blasting particle material and solvent of selectively removing the blasting particles from the surface with the solvent after the roughening of the implant surface by blasting such that an implant surface is obtained which is substantially free of blasting particles and is decontaminated in this manner.

In the method of the first embodiment, a cleaning of the roughened surface with industrial alcohol can be carried out before the treatment of the surface with the nitric acid such that the surface can be completely wetted by the nitric acid in the following step. In addition, the nitric acid can be conditioned during the treatment of the surface by, for example, precipitation of the dissolved iron. Consequently, the nitric acid maintains it activity during the treatment of the surface such that the surface can be liberated from the iron particles almost free of any residue.

Other acids such as phosphoric acid (H₃PO₄) or sulphuric acid (H₂SO₄) can also be used instead of nitric acid. Furthermore, the implant surface can also consist of a tantalum (Ta), a zirconium (Zr) and a niobium (Nb) alloy. Even stainless steels and cobalt chromium (Co/Cr) alloys can be treated with the method of the first embodiment.

In a second embodiment, a material combination of a metallic surface material, a metallic blasting agent and an electrolytic bath as the solvent is selected in which the metallic blasting agent has a lower standard reference voltage in the electrical voltage series than the metal of the implant surface. The blasting agent remaining in and/or on the surface after the blasting can thus be selectively removed from the surface by anodic oxidisation without the surface material being attacked and the rough surface structure being substantially changed.

In accordance with the invention, blasting agents are therefore used here in the blasting of an implant surface which detach or dissolve in a subsequent chemical or electrolytic treatment (stripping) without the material of the implant surface being substantially attacked.

In the following examples, blasting particles STEELETTS GH of the company of WHEELABRATOR-ALLEVARD made of edged, broken cast steel blasting grains with a chemical analysis C≧0.85%; P<0.05%; S<0.05% and a hardness HV1>860 are used. The STEELETTS GH used had the following grain size distributions: GH-16 1.7-1.0 mm; GH-25 1.18-0.355 mm; GH-80 0.425-0.125 mm; GH-120 0.3-0.075 mm. The blasting took place in a blasting booth in which the blasting pressure and the distance of the nozzle from the surface to be treated was adjustable.

### EXAMPLE 1

Disk-shaped samples with a diameter of 42 mm and a thickness of approximately 6 mm made of PROTASUL-100 (Ti-6Al-7Nb) and PROTASUL-Ti (pure titanium) were blasted with blasting particles GH-25 at a blasting pressure of 4.5 bar and a distance of the blasting nozzle from the sample of 200 mm until the surface appeared uniformly matt grey. Subsequently, the samples were immersed at room temperature (21° C.) in respective mechanically stirred 10% solutions of the following acids, i.e. were stripped: nitric acid HN_{O}₃, phosphoric acid H₃PO₄, sulphuric acid H₂SO₄. After stripping times of 30 and 60 minutes, the samples were steam sterilised in the autoclave (3 bar/30 minutes). The residual iron amount on the samples in the form of rust points was evaluated in dependence on the acid and on the stripping time in a semi-quantitative manner. The same treatment was carried out with a 10% hydrochloric acid HCl as a comparison example, The results are collected in the following table:

TABLE 1

| Stripping | Stripping | Residual iron in the form of rust spots | | |
|---|---|---|---|---|
| agent | time | None | Few | Many |
| H₂SO₄ | 30 | | | X |
| | 60 | | X | |
| H₃PO₄ | 30 | | | X |
| | 60 | | X | |
| HNO₃ | 30 | X | | |
| | 60 | X | | |
| HCl | 30 | | | X |
| | 60 | | | X |

As can be seen from Table 1, the best results are obtained with the samples of pure titanium and of a titanium alloy with a 10% nitric acid (HNO₃), since after only a stripping time of 30 minutes no residual iron was visible in the form of rust spots after the autoclave treatment. The treatment with phosphoric acid and with sulphuric acid also resulted in satisfactory results, but, in the treatment with these acids, a stripping time of at least 60 minutes, preferably 90 minutes, has to be observed to achieve an implant surface which is substantially free of residual iron.

### EXAMPLE 2

Samples of PROTASUL-100 and PROTASUL-Ti with the same specifications as the samples used in Example 1 were blasted with blasting particles GH-80 at a blasting pressure of 4.5 bar and a distance of the nozzle from the sample of 200 mm. Nitric acid and phosphoric acid with a concentration of 10% and 20% were used as the stripping agents. These solutions were mechanically stirred at room temperature (21° C.), the samples were immersed in the respective solutions for 30 minutes, 60 minutes and 120 minutes. The samples were subsequently steam sterilised in the autoclave and evaluated in a semi-quantitative manner for residual iron as in Example 1 by means of rust spots. For comparison, the same treatment was moreover carried out with a 40% nitric acid and a stripping time of 30 minutes. The results are collected in the following table.

TABLE 2

| Stripping | Stripping | Residual iron in the form of rust spots | | |
|---|---|---|---|---|
| agent | time | None | Few | Many |
| H₃PO₄ | 30 | | X | |
| 10% | 60 | | X | |
| | 120 | | X | |
| H₃PO₄ | 30 | | X | |
| 20% | 120 | | X | |
| HNO₃ | 30 | X | | |
| 10% | 60 | X | | |
| | 120 | X | | |
| HNO₃ | 30 | X | | |
| 20% | 120 | X | | |
| HNO₃, 40% | 30 | | | X |

After the treatment with the 10% nitric acid, no rust spots were able to be observed on the blasted surfaces after a stripping time of only 30 minutes. The treatment with phosphoric acid likewise produced satisfactory results, since only a few rust spots were observed. An increase in concentration of the solvent to 20% had no negative effect on the results either with the treatment with nitric acid or with the treatment with phosphoric acid.

However, the comparison example of the treatment with a 40% HNO₃ shows that the increase of the nitric acid concentration to 40% has a disadvantageous effect since a lot of rust spots were still recognisable after the steam sterilisation. The residual iron could no longer be stripped off satisfactorily due to the reduction of the activity of the nitric acid associated with the concentration increase.

### EXAMPLE 3

Disk shaped samples of PROTASUL-100 (Ti-6Al-7Nb), PROTASUL-64WF (Ti-6Al-4V) and PROTASUL-Ti (pure titanium) were blasted with the blasting particles GH-80 used in Example 2 at a blasting pressure of 4.5 bar and at a distance of the nozzle from the sample of 200 mm. The surfaces were subsequently each immersed in 10%, mechanically stirred HNO₃ solutions at 21° C. for 15 minutes and 30 minutes. Then the samples were exposed to a condensate test climate of 40° C. and 100% humidity in a climatic chamber for one hour to make visible the iron contamination in the form of rust spots. Non-stripped samples were also put in the climatic booth as comparison examples to the samples stripped with HNO₃.

After the treatment in the climatic chamber, the non stripped samples were covered with innumerable rust spots. With the samples which were treated with HNO₃ for 15 minutes, individual rust spots were observed, and after a treatment time of 30 minutes no iron contamination was present any longer.

### EXAMPLE 4

4 samples each of PROTASUL-Ti, PROTASUL-64WF and PROTASUL-100 with a diameter of 42 mm were blasted with STEELETTS GH-16, GH-25, GH-80 and GH-120 at a blasting pressure of 4.5 bar and a distance of the nozzle from the respective samples of approximately 200 mm. Treatment was subsequently carried out with 10% nitric acid which was stirred mechanically at room temperature (21° C.) while observing the following stripping time: 30 minutes for STEELETTS GH-80. Subsequently, two samples each were stored in 250 ml 10% HNPO₃ for 5 hours. Two unblasted samples served as comparison samples. Then the iron content was determined in the respective HNO₃ solutions.

An iron content of the respective HNO₃ solutions resulted for the non blasted reference samples of less than 0.2 mg/l. The iron content of the HNO₃ solutions in which the blasted samples were stored amounted to 1.4 mg/l. The iron contamination thus amounts to 0.0126 mg Fe/cm². Accordingly, the residual contaminations of the blasted samples are so low that they can be neglected. An additional visual examination for iron contamination after a one hour treatment in the climatic chamber with a condensate test climate of 40° C. and 100% humidity which was carried out on the surface before the storage in HNO₃ showed that no rust spots were recognisable for the blasted samples.

### EXAMPLE 5

Disk shaped samples of PROTASUL-Ti, PROTASUL-64WF and PROTASUL-100 were blasted with STEELETTS GH-16, GH-25, GH-80 and GH-120. Subsequently, the samples blasted with the different STEELETTS GH were treated as described under Example 3 with 10% nitric acid. The surface roughness was measured using a mechanical scanning unit of the company of Perthen, Perthometer S5P, with a scanner RHTR2-50 with a measuring length of 4.8 mm and a limit wavelength of 0.8 mm. The results are collected in the following table:

TABLE 3
STEELETTS GH-120

| | Blasting | Surface roughness (μm) | | | | | |
|---|---|---|---|---|---|---|---|
| | pressure | Before stripping | | | After stripping | | |
| Material | (bar) | Ra | Rz | Rmax | Ra | Rz | Rmax |
| P-Ti | 1.0 | 3.0 | 20 | 24 | 2.6 | 19 | 23 |
| P-100 | 1.0 | 2.9 | 19 | 21 | 2.9 | 18 | 23 |
| P-Ti | 4.5 | 5.2 | 30 | 35 | 5.0 | 29 | 32 |
| P-100 | 4.5 | 5.3 | 31 | 35 | 4.8 | 28 | 32 |

TABLE 4
STEELETTS GH-80

| | Blasting | Surface roughness (μm) | | | | | |
|---|---|---|---|---|---|---|---|
| | pressure | Before stripping | | | After stripping | | |
| Material | (bar) | Ra | Rz | Rmax | Ra | Rz | Rmax |
| P-Ti | 4.5 | 7.1 | 41 | 60 | 5.2 | 30 | 33 |
| P-64WF | 4.5 | 6.6 | 36 | 42 | 5.1 | 30 | 35 |
| P-100 | 4.5 | 5.1 | 37 | 50 | 5.0 | 29 | 32 |

TABLE 5
STEELETTS GH-25

| | Blasting | Surface roughness (μm) | | | | | |
|---|---|---|---|---|---|---|---|
| | pressure | Before stripping | | | After stripping | | |
| Material | (bar) | Ra | Rz | Rmax | Ra | Rz | Rmax |
| P-Ti | 4.5 | 11 | 66 | 80 | 7.6 | 41 | 54 |
| P-64WF | 4.5 | 11 | 53 | 60 | 6.5 | 42 | 51 |
| P-100 | 4.5 | 9 | 51 | 83 | 7.7 | 43 | 53 |

TABLE 6
STEELETTS GH-16

| | Blasting | Surface roughness (μm) | | | | | |
|---|---|---|---|---|---|---|---|
| | pressure | Before stripping | | | After stripping | | |
| Material | (bar) | Ra | Rz | Rmax | Ra | Rz | Rmax |
| P-Ti | 4.5 | 13 | 66 | 85 | 14 | 70 | 90 |
| P-64WF | 4.5 | 13 | 65 | 95 | 12 | 59 | 76 |
| P-100 | 4.5 | 14 | 72 | 96 | 12 | 58 | 73 |

As can be seen from the tables, the roughness values before stripping are a little higher than after stripping. This results from the fact that, due to the treatment with nitric acid, the iron contamination is removed, but the titanium material is practically not attacked, i.e. only to a degree which has no negative influence on the roughness required for the practical use. The samples which were blasted with GH-25, GH-80 and GH-120 resulted in satisfactory roughness values. The test platelets blasted with STEELETTS GH-6 also showed individual rust spots after 3 hours after a treatment in the autoclave as described in Example 1. For this reason, the stripping time has to be extended to approximately 4 hours for surfaces blasted with GH-16 and therefore having very high roughness values.

### EXAMPLE 6

The rotating bending fatigue limit was determined on the bar shaped samples of PROTASUL-100 with a diameter of 4 mm. The surface of the samples was previously blasted with STEELETTS GH-80 and treated as described under Example 3. A surface roughness of the samples resulted of Ra 5 up to 6 μm and Rz 30 up to 35 μm.

For comparison, a corresponding PROTASUL-100 sample was blasted with corundum and subjected to the same test. The test results are listed in the following table:

TABLE 7

| Rotating bending fatigue limit (10⁷ cycles) | (MPa) |
|---|---|
| STEELETTS blasted/PROTASUL-100 | approx. 460 |
| Corundum blasted/PROTASUL-100 | approx. 500 |

The rotating bending fatigue limits of samples blasted and treated in accordance with the invention are lower by approximately 10% in comparison with the samples only blasted with corundum, but are still satisfactory with respect to the rotating bending fatigue limit required in practice for implants.

### EXAMPLE 7

Dynamic strength investigations were carried out of surfaces blasted with STEELETTS on hip prosthesis models of ZWEYMÜLLER, SPOTORNO and MÜLLER. The starting material was mechanically finally processed prostheses which were blasted, stripped (i.e. treated for 30 minutes with 10% HNO₃) and checked for iron contamination as described under Example 1. Subsequently, the samples were washed and the surface roughness measured. A ZWEYMÜLLER hip prosthesis was blasted with corundum for comparison.

ZWEYMÜLLER: Hip prosthesis, Size. 1 (Art. No. 2841):

After stripping, rust spots were found on the prosthesis in the proximal bores. After substitution of approximately 30% water with industrial alcohol, the surface tension of the stripping solution fell so that subsequently stripped stems of ZWEYMULLER prostheses were also free of rust in the proximal bores.

SPOTORNO hip prosthesis, Size 7 (Art. No. 29.00.09-070):

A 10% nitric acid without alcohol was used as the stripping solution. After stripping, no rust spots could be recognised in the medial strike-out bore.

MÜLLER straight stem, Size 7.5 (Art. No. 23.00.59-075):

Stripping was also carried out without alcohol here and rusts spots were found in the medial strike-out bore after stripping.

TABLE 8

| | Surface roughness | | | |
|---|---|---|---|---|
| ZWEYMÜLLER: | | | | |
| STEELETTS GH-80 blasted | Ra 5.2 μm | Rz | 31 μm | Rmax 39 μm |
| Corundum | Ra 5.4 μm | Rz | 32 μm | Rmax 43 μm |
| SPOTORNO: | | | | |
| STEELETTS GH-80 blasted | Ra 4.7 μm | Rz | 29 μm | Rmax 37 μm |
| MÜLLER: | | | | |
| STEELETTS GH-80 blasted | Ra 5.2 μm | | 30 μm | Rmax 36 μm |

The dynamic strength examinations were carried out according to the standard ISO 7206/3 (without lateral stem inclination) and according to the standard ISO/DIS 7206/4 (with 9° lateral stem inclination) (end of trial: 5 million cycles).

TABLE 9

| ZWEYMÜLLER | ISO 7206/3 (0°) | ISO/DIS 7206/4 (9°) |
|---|---|---|
| STEELETTS GH-80 | 300/5800N | 300/3800N |
| Corundum blasted | 300/5800N | 300/3800N |

TABLE 10

| SPOTORNO | ISO 7206/3 (0°) | ISO/DIS 7206/4 (9°) |
|---|---|---|
| STEELETTS GH-80 | Not tested | 300/4800N |
| Corundum blasted | 300/6300N | 300/5300N |

TABLE 11

| MÜLLER | ISO 7206/3 (0°) | ISO/DIS 7206/4 (9°) |
|---|---|---|
| STEELETTS GH-80 | 300/3800N | 300/8300N |
| Corundum blasted | 300/3800N | 300/8300N |

As can be seen from the tables, the dynamic strength of the tested ZWEYMÜLLER prostheses is equally high in the simulation loosened state for surfaces which were blasted with STEELETTS and with corundum.

The SPOTORNO hip stem prosthesis blasted with STEELETTS was only tested according to the standard ISO/DIS 7206/4. 300/4800N was determined as the permanently bearable load.

The MÜLLER straight stem prosthesis was tested in the simulation loosened state according to the standard ISO/DIS 7206/4. With the load of 300/3800N, no break occurred over 5 million cycles. In addition, neck tests with fully cemented prosthesis were carried out according to ISO/DIS 7206/4. The Muller stems passed more than 10 million cycles without breaking with the threshold load of 300/8300 Newtons.

Overall, no significance strength differences were able to be found in the examined hip prostheses of ZWEYMÜLLER, SPOTORNO and MULLER between surfaces blasted with STEELETTS and surfaces blasted with corundum.

### EXAMPLE 8

Potentio-dynamic corrosion trials were carried out on a blasting agent and on pure titanium in accordance with the standard ASTM G5, with the following parameters being selected: scanning rate 10 mV/min, 0.9% NaCl solution with a pH of 4, temperature of the NaCl solution 40° C. The pH of the NaCl electrolyte was set with a 10% HCl solution. The NaCl solution was bubbled through with nitrogen during the total trial. A saturated calomel reference electrode (SCE) was used as the reference electrode.

The test sample was connected to an electric cable and embedded into a self-hardening plastic. The surface preparation took place by grinding up to grain 1200.

Blasting Agent GH-80

Cast steel blasting grains STEELETTS GH-80 were processed to a test sample and examined as-part of the potentio-dynamic corrosion trial. This blasting agent is a hypereutectoid steel with a carbon portion of >0.85%. To allow an electrochemical characterisation to be carried out, melting tests were made. For this purpose, the powdery blasting agent was processed in a melting process in vacuum (Vacumet AG, Winterthur) to a sample with a diameter of approximately 20 mm and a height of approximately 10 mm.

The potentio-dynamic corrosion trial showed that the equilibrium rest potential of the blasting agent GH-80 lies at approximately −850 mV. As the potential increases, the current density increases, with the dissolving rate increasing strongly in the potential range from −800 mV to 0 mV, but increasingly less strongly as the potential increases further. With a potential of +800 mV, the current density lies at approximately 0.1 A/cm² or 100,000 μA/cm². After the end of the trial, the total test solution had a black-brown colour due to the massive dissolving of the iron.

Pure Titanium

Pure titanium, degree of purity 4, was tested as a reference sample, likewise in a potenio-dynamic trial under the same conditions.

It was found that the equilibrium rest potential lies at approximately −550 mV. From approximately −300 mV, the passive range starts, i.e. the range in which the current density remains constant independently of the increasing potential. The current density in this range lies at approximately 1 μA/cm².

Potentio-static corrosion trials were subsequently carried out on pure titanium samples contaminated with blasting agent. For this purpose, as with the potentio-dynamic corrosion trial, the pure titanium samples were embedded and ground. Individual, small holes were hammered into the pure titanium with a hardened metal tip. The holes were then filled with individual blasting agent grains GH-80 and subsequently driven into the cut-out with the same metal tip used for the holes.

In the potentio-static trials, the sample was exposed to a constant potential. The trial was carried out at a potential of +300 mV and the resulting current density was measured for two hours. The remaining trial parameters are identical to those of the potentio-dynamic corrosion trials.

The potentio-static trials showed that the current density reduced over time. After two hours, only individual iron inclusions were still able to be detected on the titanium surface. As a result, the trials showed that a cleaning effect was achieved.

It follows from the trials of Example 8 that a pure titanium surface contaminated with cast steel blasting grains can be selectively liberated from the blasting grains by an electrolytic treatment. The initially carried out electrochemical characterisation as part of the potentio-dynamic corrosion trials documents that the standard reference voltage of the materials of the blasting particles and of the titanium surface differ sufficiently so as to only be able to attack the iron blasting particles electrolytically. The potentio-static trials further showed that a cleaning effect is achieved in the electrolytic treatment in that iron contamination is selectively dissolved or detached in a pure titanium surface.

The electrolytic treatment, for example the above-described potentio-static method, can also be carried out in combination with a chemical treatment of the surface. The cleaning effect can be improved in this manner. Electrolytes on a watery basis, for example acidic electrolytes, can be used as the combined chemical and electrolytic bath. The potential can be set in the range from −500 mV to +800 mV for the cleaning of a pure titanium surface from iron blasting particles. To avoid too low a potential only slowly dissolving the steel and too high a potential damaging the titanium surface, however, a potential is to be preferred in the range from +100 mV to +500 mV, in particular a potential of +300 mV.

The examples show that a medical implant, in particular a joint prosthesis, e.g. a hip joint prosthesis, can be manufactured by the method in accordance with the invention, which has a titanium surface free of contamination. The roughness of the surfaces blasted with STEELETTS GH-80 is comparable with conventional surfaces blasted with corundum. Even higher roughness values can be achieved with correspondingly coarser steel scraps. Significant strength differences, measured at rotating bending samples and hip prostheses of the same roughness, could not be found between surfaces blasted with STEELETTS and surfaces blasted with corundum.

To summarise, it can be said that the implant surfaces and implants manufactured by the method in accordance with the invention satisfy all demands required for prostheses in the medical sector. In addition, the blasted surfaces manufactured in accordance with the invention are almost free of contamination so that complications due to “wandering” blasting particles, i.e. blasting particles detaching after the implanting, can be avoided.

1. A method for the manufacture of an implant, in particular of a metallic implant comprising the steps of
roughening the surface of the implant by blasting with blasting particles; and
treating the surface with a solvent which selectively dissolves the blasting particles.

2. A method for the decontamination of a surface treated with blasting particles, in particular of a metallic implant surface treated with blasting particles, characterised by treating the surface with a solvent which selectively dissolves the blasting particles.

3. A method in accordance with any one of the preceding claims, in which the treatment of the surface takes place by means of a chemical and/or an electrolytic bath.

4. A method in accordance with any one of the preceding claims, in which an acidic solvent is used in which the material of the implant is substantially insoluble.

5. A method in accordance with any one of the preceding claims, in which the treatment of the surface includes an immersion of the surface into a mechanically stirred acid as the solvent.

6. A method in accordance with any one of the preceding claims, in which the solvent comprises HNO₃, H₃PO₄ and/or H₂SO₄.

7. A method in accordance with any one of the preceding claims, in which the treatment of the surface includes an electrolytic treatment with an electrolyte as the solvent, in particular an anodic oxidisation.

8. A method in accordance with any one of the preceding claims, in which the treatment of the surface includes an electrolytic treatment in an acid NaCl solution at 20 to 25° C. and at −500 to +800 mV.

9. A method in accordance with any one of the preceding claims, in which the treatment of the surface includes an electrolytic treatment in an 0.9% NaCl solution of pH 4 at 40° C. and at +300 mV.

10. A method in accordance with any one of the preceding claims, in which a cleaning of the surface takes place before the treatment with the solvent.

11. A method in accordance with any one of the preceding claims, in which the solvent is prepared during the treatment of the surface.

12. A method in accordance with claim 11, in which the solvent is prepared by precipitation of the dissolved blasting particles.

13. A method in accordance with any one of the preceding claims, in which the material of the surface comprises a metal.

14. A method in accordance with claim 13, in which the material of the surface comprises Ti, an alloy of Ti, Ta, Zr, Nb, Co/Cr, or stainless steel.

15. A method in accordance with any one of the preceding claims, in which the blasting particles include iron particles, in particular hardened iron particles.

16. A method in accordance with any one of the preceding claims, in which
the surface comprises titanium or a titanium alloy;
the blasting particles include iron particles; and
the treatment of the surface includes an approximately 30 minute immersion of the surface into a mechanically stirred, approximately 10% HNO₃ solution at room temperature.

17. A method in accordance with claim 16, in which a cleaning of the surface with industrial alcohol takes place before the treatment of the surface.

18. A method in accordance with any one of the preceding claims, in which the solvent is prepared during the treatment of the surface by a precipitation of the dissolved blasting particles, in particular by an iron precipitation.

19. A medical implant, in particular a joint prosthesis, having a surface which can be achieved by a method in accordance with any one of the preceding claims.
